(19) United States
(12) Patent Application Publication
(10) Pub. No.: US 2016/0203112 A1
(43) Pub. Date: Jul. 14, 2016

(54) METHOD AND ARRANGEMENT FOR PROCESSING AND PROVIDING MEDIA CONTENT

(71) Applicant: DooWapp Limited, London (GB)

(72) Inventors: Yaw ASAMANI, London (GB); George ASAMPONG, Chislehurst, Kent (GB); George ASAMANI, London (GB)

(21) Appl. No.: 14/912,955

(22) PCT Filed: Jul. 29, 2014
(86) PCT No.: PCT/EP2014/066288

§ 371 Date: Feb. 19, 2016

Related U.S. Application Data
(60) Provisional application No. 61/867,178, filed on Aug. 19, 2013.

(51) Int. Cl. G06F 17/22; H04L 12/58; G06Q 30/02; G06F 17/27; G06F 3/0484; H04W 4/14; G06F 17/24

(52) U.S. Cl. CPC G06F 17/2235; H04W 4/14; H04L 51/04; G06F 17/24; G06F 17/27; G06F 3/0484; G06Q 30/0277

(57) ABSTRACT

The present invention relates to a method, device and server for providing a digital content including a digital multi-media to a receiver with additional expression to the digital content. The method comprises: accessing a first media, being a limited portion of a second media, said first media having a digital start position and a digital end position with respect to said second media; and inserting a link in the digital content, said link being a digital address to said first media.

### TECHNICAL FIELD

The present innovation relates to systems and/or methods involving media processing in general and media data incorporated in message exchange in particular.

### BACKGROUND

Many subscribers use their handheld terminals, such as mobile phones, tablets etc. to send and receive text and media messages over wireless networks. In a simple text message, a text body is created and transmitted between the subscribers. In media case, either audio or video message is inserted into the message or a link is sent to a receiver.

One problem may be that the media messages (MMS) usually cost more than text messages (SMS) and SMS does not allow sending media files in a simple way.

Yet another problem is that a user is not able to control incorporated media data in a text message and relate it to the remaining text.

Beside messaging, there is a similar need for inserting media in digital medias, such as e-mails, digital magazines and articles, adverts etc.

### SUMMARY

The present invention solves the above problems and also provides enhanced features such as:
Ability to stream media, especially music segments without needing music service applications installed;
Provide additional (personal) expressions in a message using portions of a media;
Large catalogue of music across all labels may be used;
Use support on all major mobile phone and mobile terminal operating systems
Ability to sign up to media services; and
Ability to purchase media;
Opportunity for new users to sign up to service; and
Opportunity to increase information and thus sales to existing users.

One object of the present invention is to create an Instant Messaging (IM) arrangement that may mirror the default IM/SMS/MMS for mobile terminal such as mobile phones, especially so called smart phones. Another object is to provide tools for handling media and inserting into e-mails, digital magazines and articles, adverts etc.

The invention provides an ability to input media, and especially sound clips/song quotes in a message or comment box whilst messaging. Recipients of that message will be able to read and view/hear the sound clip/song quote that was incorporated in the text/comment being sent. In one embodiment emoticons can be expressed as audio clips.

As set forth below, one or more features of the present inventions may overcome these or other drawbacks and/or otherwise impart innovative aspects.

For these reasons, a method of providing a digital content including a digital multimedia to a receiver with additional expression to the digital content is provided. The method comprises: accessing a first media, being a limited portion of a second media, said first media having a digital start position and a digital end position with respect to said second media; and inserting a link in the digital content, said link being a digital address to said first media. The media is one or several of audio, video, animation or video footage. The digital content may be one or several of digital text, digital presentation, e-mail, digital magazine, digital article, digital message or digital advert. In one embodiment, the media comprises music or song. In one embodiment the message is an instant message comprising a digital text message. The digital content may be transmitted from a first mobile device to a second mobile device. The first media may be accessed in a database. The method may further comprise the step of generating said first media by accessing the second media by using at least one search term in a database, playing the media and determining a start and an end position, which are stored in a database. In one embodiment, the media is a music media and start and end position is based on lyrics. The end position is added automatically to the start position. The method may further comprise the step of generating said first media automatically by means of a computer. In one embodiment, the method may further comprise associating said media portion with a digital address and storing said media portion with said digital address. The link may be a hyperlink. The method may further comprise transmitting said digital content to a recipient. The method may further comprise accessing said link by the recipient and using said link to access said first media in a database. The link comprises a digital address and a unique media identifier. The link may be presented as a title and/or lyric of said media. The link may insert lyrics to said digital content. The method may comprise analyzing content of the digital content and adopting the first media to said content. The analyzing may comprise analyzing one of the text or an image content.

The invention also relates to a method of increasing or promoting selling of a media. The method comprises providing a digital content including a digital multimedia to a receiver, accessing a first media, being a limited portion of said media; and inserting a link in the digital content, said link being a digital address to said first media, sending to a receiver to generate interest for said media.

The invention also concerns a communication device, at least comprising a processing unit and a communication portion, said processing unit being configured to generate a digital content and provided said digital content with additional expression to the digital content: access a first media, being a limited portion of a second media, said first media having a digital start position and a digital end position with respect to said second media;

and insert a link in a digital content, said link being a digital address to said first media.

The invention also relates to a computer device at least comprising a processing unit, a storage unit and a communication unit, wherein the processing unit is configured to: deceive instructions to retrieve at least a portion of a multimedia stored in said storage unit from a user, provide a digital address to said user, play said at portion when requested by a said first or a second user.

### BRIEF DESCRIPTION OF THE DRAWINGS

Reference is made to the attached drawings, wherein elements having the same reference number designation may represent like elements throughout.

FIG. 1 is a diagram of an exemplary system in which methods and systems described herein may be implemented;

FIG. 2 is an exemplary message body according to the invention;

FIG. 3 is a flow diagram illustrating exemplary processing by the system of FIG. 1,

FIG. 4 illustrates a table realizing database entries, according to the present invention;

FIG. 5 illustrates schematically a communication device according to one embodiment of the present invention; and

FIG. 6 illustrates schematically a computer device according to one embodiment of the present invention.

### DETAILED DESCRIPTION OF PREFERRED EMBODIMENTS

In the following various embodiments of the present invention will be described with reference to a wireless communication system, which allows transmitting instant messages (IM) in from of e.g. text messages and incorporating media data in form of audio information, preferably music.

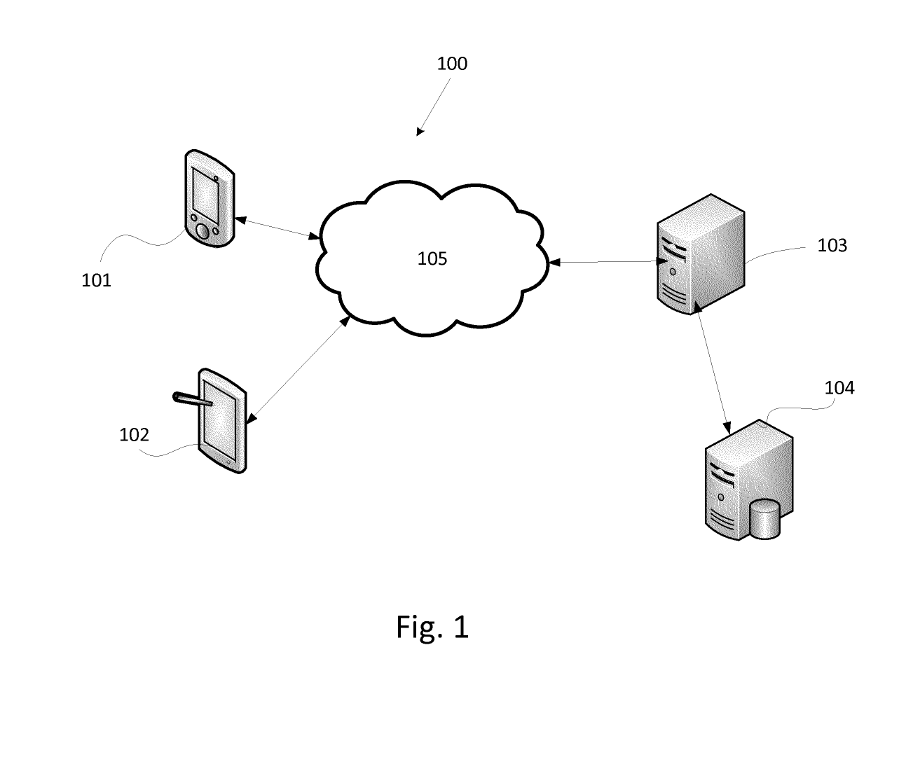

FIG. 1 illustrates one aspect of the invention system 100 comprising a first mobile device 101, a second mobile device 102, a wireless communication network 105, a service provider server 103 and an optional media server 104.

According to this example, user of first device 101 sends a message, e.g. an IM in form of a text message, to the user of the second mobile device 102. The idea is that the user of the first device 101 inserts a music quote as part of the message. Sometimes, the user may use emoticons as part of the message, e.g. for expressing emotions (happy, sad, etc.). Due to issues with, e.g. copyright, storage size and other limitations to insert full audio file, the invention allows the user to create a portion (segment/quote) of the full audio file (which corresponds exactly to the song quote) and insert a link (hyperlink) to the created part in the message. The user may also choose a premade or prepared portion.

In the example of FIG. 1, the service provider 103 (SP) provides access to audio files or segments of the audio files. The access may be to references to audio files or segments of the audio files.

The audio files, especially music may be provided from a music service 104, such as ITUNES, SPOTIFY, SOUNDCLOUD, 7Digital, etc.

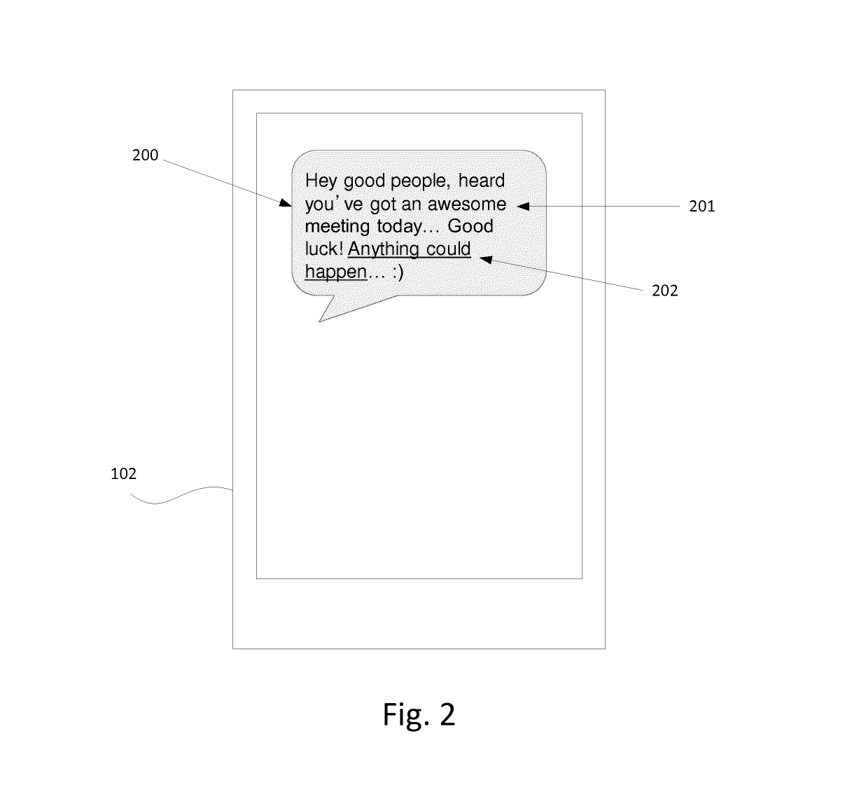

An exemplary message 200 according to the present invention as displayed on the display of a mobile device 102 is illustrated in FIG. 2. The message comprises a text portion 201 and a link 202 (underlined part).

When the user of the receiving device receives the message, the link is activated by choosing the link part.

The invention is detailed in the following:

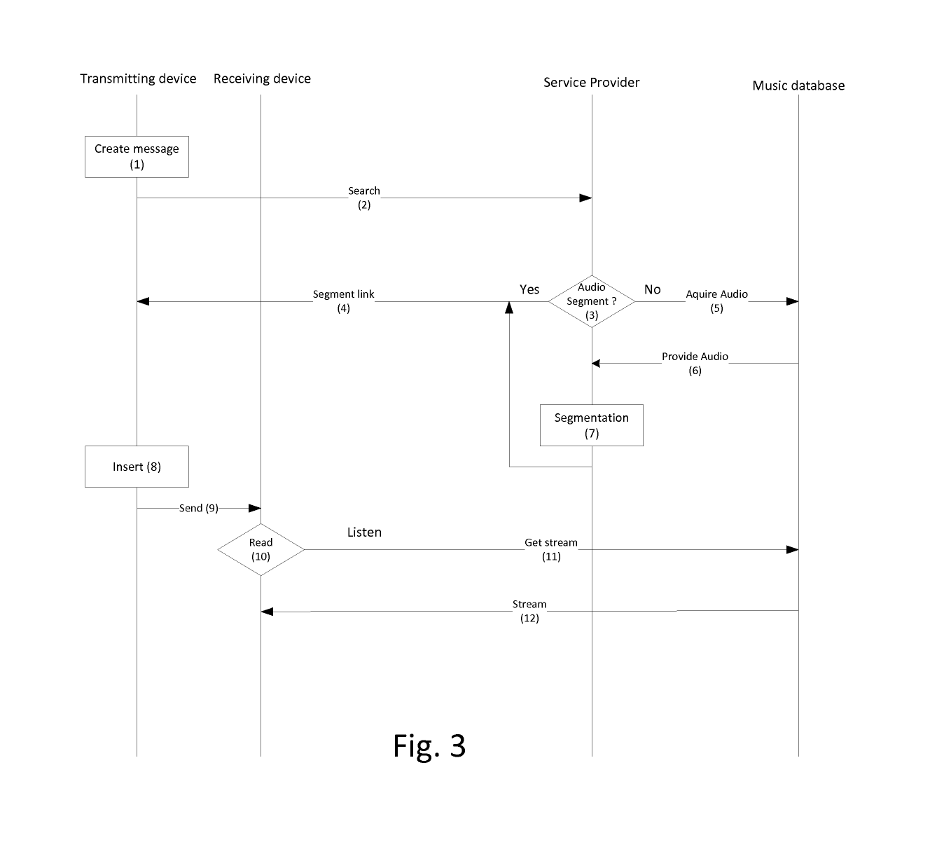

FIG. 3 illustrates a flow diagram showing various steps according to one aspect of the invention. In the following the invention is exemplified with reference to an embodiment for insertion of music segments.

Firstly, a dedicated program (application/app) may be installed in the device of the first user (sender). The user may also use online services for transmitting a message according to the present invention. When the user wants to send a text message, the user starts the app or a SMS application for generating (1) a message text.

If the user wants to insert a music segment, he establishes a connection to the SP 103. The connection may be automatically upon starting the app, the SMS editor, using menus or a short command.

When connected to SP, the user searches (2) for a music-segment in the SP's database. The user may use, title, artist name, (parts of) lyrics, song mode (happy, sad, love, etc.) or any other relevant information identifying the music (segment) or song. A search engine in the SP server may assist the user to search by providing lists, suggestions, etc.

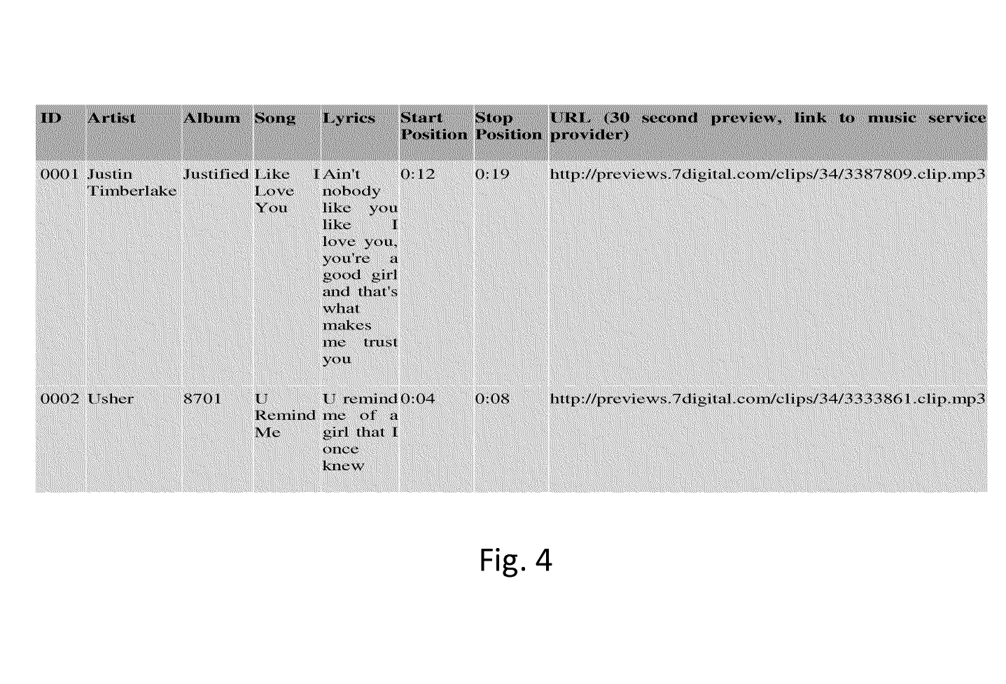

FIG. 4 illustrates an exemplary database entry at SP. According to this example, the database header includes song ID, Artist name, Album name, Song name, Lyrics (at least part of it), segment start position, segment stop position, and a link address to a music provider and/or storage location. Due to copyright legislation in different jurisdictions or other issues mentioned earlier, the provided segment and/or the link may be limited, e.g. to 30 seconds.

If the music segment is in the database, SP returns (4) a link, which can be inserted into the text message. In one embodiment, the lyrics or a link to lyrics may be returned. In the example of FIG. 3, if the user chooses song No. [0002] a link to the song with start from time stamp 0:12 to 0:19 will be inserted (8) into the text message. The link may be inserted using the title or lyrics, i.e. in the message is shown: the title or lyrics and the ID which represents the entry in the service provider database is stored in the background. The user may choose which part of the lyrics/title is used in the message by highlighting/marking the part.

If no segments are found in the database, there may be two options: to generate a segment by the SP (or other party in the system) or by the user:

In the user case, the user may access a song, e.g. by using song name, artist name, etc., from the SP database or music database, play the song and determine a start and an end position, which are stored in the database, e.g. in users account, and/or the SP database. In one embodiment, the end position may be added automatically to the start position, e.g. 5 seconds. The user may also be provided with lyrics while the song is playing and choose start and end positions based on the lyrics. Lyrics can be obtained from by the SP or a lyrics provider service.

The song provided for segmentation may be a portion of the song. The segment generated by the user may be played back (with lyrics being displayed) for confirmation. In one embodiment, the user may insert own or other lyrics into a song.

In the case of automatic segmentation, the SP-server (or other server) may randomly determine a segment or analyse the music and based on predetermined criteria or criteria provided by the user generate a segment. The segment may be stored in the database and/or a user account.

When a segment is generated (and stored) the link is sent (4) to or copied by the user, and inserted (8) in the message body, automatically by the application or manually by the user.

When the massage is ready, the user hits the send bottom and sends (9) the message to one or several recipients. In one embodiment, each recipient has a profile and can be associated with a music type and receive linked messages based on the profile.

In one embodiment, the recipient must run same app in his device to be able to listen to the music segment. In another embodiment, the music may be played using pre-installed players.

When the recipient receives the message and starts reading (10) it, he/she may click on the link within the digital body of text (or select in menu), the device connects (11) to the

SP server and a lookup against the SP song segmentation database is established to retrieve the appropriate record from the database using the encoded id. For example when the link in the following encoded message is clicked “Hey Love<a href=“0002”>U remind me of a girl that I once knew</a>” (which would render as Hey Love U remind me of a girl that I once knew record 0002) would be retrieved using the table illustrated in FIG. 3. Once the record is retrieved, there may be two options:

1. Full deal with music database: Connection (12) is made to the music database using the URL, start position and stop position. The song is streamed (13) back to the user (which can be set to play in a loop) between the start and stop position or the song segment is fully downloaded (13) onto the recipient device (e.g. in a temporary location) and then played back (14).

2. Making the use of free portion: Connection (12) is made to the music database using the URL. The full free portion may be downloaded (13) or streamed to the device and then the devices internal music player uses the start and stop positions to play back (14) the required section of the song in a loop.

Thus, the recipient receives a message and plays the media. In the case of music, the recipient may also obtain lyrics in the message or additional view.

The foregoing example, describes music as the media link and an IM as a carrier. However, for a person skilled in the art, it is obvious that the media may also include video, speech, animations, video footage, etc. The media segment may be inserted in texts, presentations, e-mails, digital magazines, articles, adverts, etc. The terms song/music quote/segment/part as used herein refer to section of (or substantially entire) a digital audio file and likewise may be used for in relation with above mentioned medias.

In one embodiment, the user terminal may analyse the text and search for term(s) that may associate to a song (media) with a specific meaning. For example, the analyser may detect word “happy” in the text and search for songs (or other media) having the word “happy” in the title and/or lyrics or search for the category “happy” media. In the latter case, the media portions stored in the database may be categorized, e.g. for different emotional feelings when stored. Consequently, when the word “happy” is detected, a link to a media associated with word “happy” may be inserted into the message or a number of media associated with “happy” proposed to the user for selection and insertion to the message.

In yet another embodiment, the analyser may comprise an image analyser or facial analyser, which for example based on a “selfie” (self-portrait) and/or another person's image and/or objects in the image detected may provide a link to a media associated with the mode of the face or motive of the image to be inserted into the message or a number of media associated with the mode of the face or motive of the image, propose a media to the user for selection and insertion to the message. Thus, if the analyser finds, for example a happy face a media associated with happy may be suggested or selected. A landscape e.g. with mountains may result in a song associated with mountains, etc.

Thus, the table of FIG. 3 may comprise additional columns for category and/or specific title/lyric words or provide a search for such words.

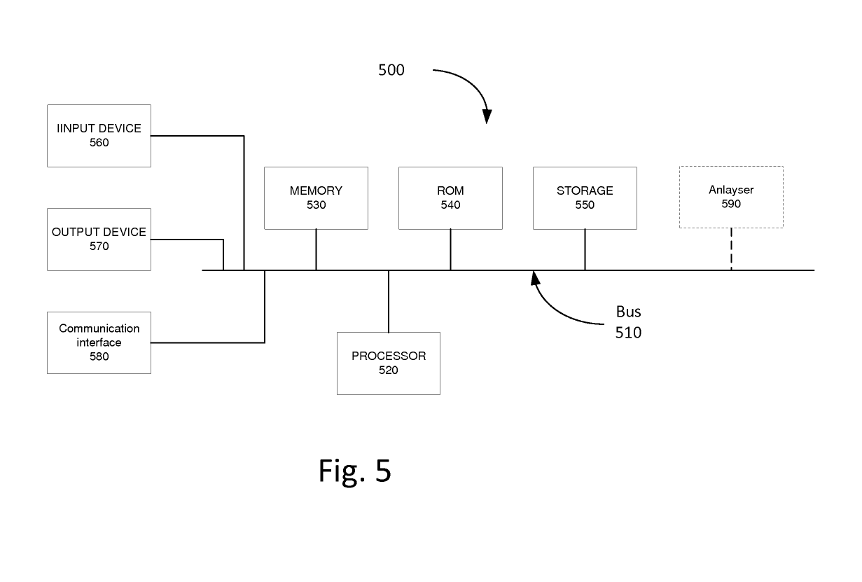

FIG. 5 is a diagram of an exemplary communication terminal 500 in which parts of methods and systems described herein may be implemented. Terminal 500 may include a bus 510, a processor 520, a memory 530, a read only memory (ROM) 540, a storage device 550, an input device 560, an output device 570, a communication interface 580, and optionally an analyzer 590. Bus 510 permits communication among the components of terminal 500. The terminal 500 may also include one or more power supplies (not shown). One skilled in the art would recognize that terminal 500 may be configured in a number of other ways and may include other or different elements.

Processor 520 may include any type of processor or microprocessor that interprets and executes instructions. Processor 520 may also include logic that is able to decode media files, such as audio files, video files, multimedia files, image files, video games, etc., and generate output to, for example, a speaker, a display, etc. Memory 530 may include a random access memory (RAM) or another dynamic storage device that stores information and instructions for execution by processor 520. Memory 530 may also be used to store temporary variables or other intermediate information during execution of instructions by processor 520.

ROM 540 may include a conventional ROM device and/or another static storage device that stores static information and instructions for processor 520. Storage device 550 may include a magnetic disk or optical disk and its corresponding drive and/or some other type of magnetic or optical recording medium and its corresponding drive for storing information and instructions. Storage device 550 may also include a flash memory (e.g., an electrically erasable programmable read only memory (EEPROM)) device for storing information and instructions.

Input device 560 may include one or more conventional mechanisms that permit a user to input information to the terminal 500, such as a keyboard, a keypad, a directional pad, a mouse, a pen, voice recognition, a touch-screen and/or biometric mechanisms, etc. Output device 570 may include one or more conventional mechanisms that output information to the user, including a display, a printer, one or more speakers, etc. Communication interface 580 may include any transceiver-like mechanism that enables terminal 500 to communicate with other devices and/or systems. For example, communication interface 580 may include a modem or an Ethernet interface to a LAN.

Alternatively, or additionally, communication interface 580 may include other mechanisms for communicating via a network, such as a wireless network. For example, communication interface may include a radio frequency (RF) transmitter and receiver and one or more antennas for transmitting and receiving RF data.

Analyser 590 may be used for analysing the content of a text and/or an image as described earlier for detecting special terms, expressions and/or objects. This functionality may also be executed by the processor 520.

Communication device 500, consistent with the invention, provides a platform through which a user may play and/or view various media, such as music files, video files, image files, games, multimedia files, etc. Communication device 500 may also display information associated with the media played and/or viewed by a user of communication device 500 in a graphical format, as described in detail below. According to an exemplary implementation, communication device 500 may perform various processes in response to processor 520 executing sequences of instructions contained in memory 530. Such instructions may be read into memory 530 from another computer-readable medium, such as storage device 550, or from a separate device via communication interface 580. It should be understood that a computer-readable medium may include one or more memory devices or carrier waves. Execution of the sequences of instructions contained in memory 530 causes processor 520 to perform the acts that will be described hereafter. In alternative embodiments, hard-wired circuitry may be used in place of or in combination with software instructions to implement aspects consistent with the invention. Thus, the invention is not limited to any specific combination of hardware circuitry and software.

In use, the memory stores the application or a program for connecting to the service provider through communication portion. User commands may be entered through a touch sensitive display or keyboard.

The term “database” as used herein concerns a storage device able of storing digital content.

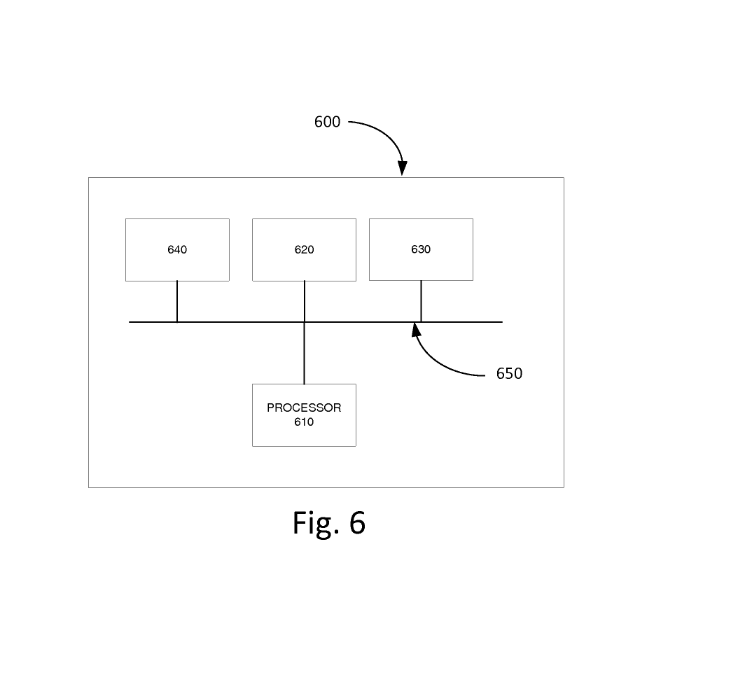

The term server in relation with both SP and music database as used herein concerns a computer 610, which in its simplest configuration comprises a processing unit 610, a memory 620, I/O interface 630 and a storage device 640, interconnected by means of a bus 650, as illustrated in FIG. 6. The server in which parts of methods and systems described herein may be implemented, may comprise a conventional computer.

The bus 650 permits communication among the components of server 600. The server may also include one or more power supplies (not shown). One skilled in the art would recognize that server may be configured in a number of other ways and may include other or different elements.

Processor 610 may include any type of processor or microprocessor that interprets and executes instructions. Processor 610 may also include logic to execute different types instructions, and generate output to, for example, displays, computer network etc. The memory 620 may include a random access memory (RAM) or another dynamic storage device that stores information and instructions for execution by processor 610. Memory 620 may also be used to store temporary variables or other intermediate information during execution of instructions by processor 610.

Additional ROM memory may be implemented and may include a conventional ROM device and/or another static storage device that stores static information and instructions for processor 610. Storage device 640 may include a magnetic disk or optical disk and its corresponding drive and/or some other type of magnetic or optical recording medium and its corresponding drive for storing information and instructions. Storage device 350 may also include a flash memory (e.g., an electrically erasable programmable read only memory (EEPROM)) device for storing information and instructions.

I/O interface 630 may include user I/O devices and communication one or more conventional mechanisms that permit a user to input information to the server, such as a keyboard, a keypad, a directional pad, a mouse, a pen, voice recognition, a touch-screen and/or biometric mechanisms, etc. I/O interface may also include one or more conventional mechanisms that output information to the user, including a display, a printer, one or more speakers, etc. I/O interface may include any means that enables the server to communicate with other devices and/or systems. For example, the interface may include a modem or an Ethernet interface to a LAN. Alternatively, or additionally, the interface may include other mechanisms for communicating via a network, such as a wireless network

According to an exemplary implementation, server may perform various processes in response to processor 610 executing sequences of instructions contained in memory 620. Such instructions may be read into memory 620 from another computer-readable medium, such as storage device 640, or from a separate device via communication interface 630. It should be understood that a computer-readable medium may include one or more memory devices or carrier waves. Execution of the sequences of instructions contained in the memory causes processor 610 to perform the acts that have been described earlier. In alternative embodiments, hard-wired circuitry may be used in place of or in combination with software instructions to implement aspects consistent with the invention. Thus, the invention is not limited to any specific combination of hardware circuitry and software.

In use, the memory stores the programs for connecting the service provider or TGS through communication portion to purchase site and user communication devices.

In one embodiment, the message may be sent through SP and the analyze of message and/or insertion of link may be executed in the SP server.

The business opportunities of the invention are several:
The application program on the handheld devices may be purchased.
Increased number of IM in telecom networks.
The audio or video segments may increase interest with the users and lead to purchase of media or sign up for services involving the media.
Licensing out the ability to send/play back song quotes,
Selling usage/trending information to record labels in the case of sharing song quotes.
Etc.

It should be noted that the word “comprising” does not exclude the presence of other elements or steps than those listed and the words “a” or “an” preceding an element do not exclude the presence of a plurality of such elements. It should further be noted that any reference signs do not limit the scope of the claims, that the invention may be implemented at least in part by means of both hardware and software, and that several “means”, “units” or “devices” may be represented by the same item of hardware.

A “terminal” or “device” as the term is used herein, is to be broadly interpreted to include a radiotelephone having ability for Internet/intranet access, web browser, organizer, calendar, a camera (e.g., video and/or still image camera), a personal communications system (PCS) terminal that may combine a cellular radiotelephone with data processing; a personal digital assistant (PDA) that can include a radiotelephone or wireless communication system; a laptop; and any other computation or communication device capable of transceiving, such as a personal computer, a home entertainment system, a television, etc.

The above mentioned and described embodiments are only given as examples and should not be limiting to the present invention. Other solutions, uses, objectives, and functions within the scope of the invention as claimed in the below described patent claims should be apparent for the person skilled in the art.

The various embodiments of the present invention described herein is described in the general context of method steps or processes, which may be implemented in one embodiment by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program modules may include routines, programs, objects, components, data structures, etc. that perform particular tasks or implement particular abstract data types. Computer-executable instructions, associated data structures, and program modules represent examples of program code for executing steps of the methods disclosed herein. The particular sequence of such executable instructions or associated data structures represents examples of corresponding acts for implementing the functions described in such steps or processes.

Software and web implementations of various embodiments of the present invention can be accomplished with standard programming techniques with rule-based logic and other logic to accomplish various database searching steps or processes, correlation steps or processes, comparison steps or processes and decision steps or processes. It should be noted that the words “component” and “module,” as used herein and in the following claims, is intended to encompass implementations using one or more lines of software code, and/or hardware implementations, and/or equipment for receiving manual inputs.

The foregoing description of embodiments of the present invention, have been presented for purposes of illustration and description. The foregoing description is not intended to be exhaustive or to limit embodiments of the present invention to the precise form disclosed, and modifications and variations are possible in light of the above teachings or may be acquired from practice of various embodiments of the present invention. The embodiments discussed herein were chosen and described in order to explain the principles and the nature of various embodiments of the present invention and its practical application to enable one skilled in the art to utilize the present invention in various embodiments and with various modifications as are suited to the particular use contemplated. The features of the embodiments described herein may be combined in all possible combinations of methods, apparatus, modules, systems, and computer program products.

1-23. (canceled)

24. A method of generating a digital content including a link to a digital song portion, said link providing additional expression to the digital content, the method comprising:
accessing a database containing a first media, containing said digital song portion comprising a segment of a substantially complete song piece, said digital song portion comprising a start position and an end position;
inserting said link in the digital content, said link being a digital address to said digital song portion in said database, and
inserting lyrics or a link to lyrics corresponding to said digital song portion into said digital content.

25. The method of claim 24, wherein said media comprises digital data representing one or several of audio, video, animation or video footage.

26. The method of claim 24, wherein said digital content is one or several of a digital text, digital presentation, e-mail, digital magazine, digital article, digital message or digital advert.

27. The method of claim 25, wherein said media comprises music.

28. The method of claim 26, wherein said message is an instant message comprising a digital text message.

29. The method of claim 24, wherein said digital content is transmitted from a first mobile device to a second mobile device.

30. The method of claim 24, further comprising:
generating said first media by accessing a second media using at least one search term in a database, and
playing the media, and
determining a start and an end position, which are stored in said or other database.

31. The method of claim 24, wherein the media is a music media and start and end positions are based on lyrics.

32. The method of claim 24, wherein the end position is added automatically.

33. The method of claim 24, further comprising the step of generating the first media automatically by means of a computer.

34. The method of claim 24, further comprising associating said song portion with a digital address and storing said song portion with said digital address.

35. The method of claim 24, wherein said link is a hyperlink.

36. The method of claim 24, further comprising transmitting said digital content to a recipient.

37. The method of claim 36, further comprising accessing said link by the recipient and using said link to access said first media in a database.

38. The method of claim 24, wherein said link comprises a digital address and a unique media identifier.

39. The method of claim 38, wherein said link is presented as a title and/or lyric of said media.

40. The method of claim 38, wherein said link inserts lyrics into said digital content.

41. The method of claim 24, comprising analyzing content of the digital content and adopting choice of the first media to said content.

42. The method of claim 41, comprising analyzing one of the text content or image content in the digital content.

43. A method of increasing or promoting selling of a media, the method comprising:
providing a digital content including a digital song portion to a receiver which provides additional expression to said digital content using said song portion and lyrics relating to said song portion;
accessing the song portion being part of a song and relating to said additional expression;
inserting a link in the digital content to said song portion, said link being a digital address to said first song portion and a lyrics database; and
sending said digital content to a receiver.

44. A communication device, at least comprising a processing unit and a communication portion, said processing unit being configured to generate a digital content and providing said digital content with a song portion comprising additional expression with respect to the digital content, the processing unit being configured to:
accessing a first media relating to said additional expression, being a limited portion of a song, said first media having a digital start position and a digital end position with respect to said song; and
inserting a link in the digital content, said link being a digital address to said song portion.

45. A computer device at least comprising a processing unit, a storage unit and a communication unit, wherein the processing unit is configured to: handle at least one or several of method steps comprising:
accessing a database containing a first media, containing said digital song portion comprising a segment of a substantially complete song piece, said digital song portion comprising a start position and an end position;
inserting said link in the digital content, said link being a digital address to said digital song in said database;
inserting lyrics or a link to lyrics corresponding to said digital song portion into said digital content;
receive instructions to retrieve at least a portion of a song stored in said storage unit from a user;
provide a digital address to said user; and
play said song portion when requested by a said first or a second user.
